(19) United States
(12) Patent Application Publication
(10) Pub. No.: US 2008/0243677 A1
(43) Pub. Date: Oct. 2, 2008

(54) SYSTEM AND METHOD FOR FLUID FINANCIAL MARKETS

(76) Inventors: Jason J. HOGG, Orangeburg, NY (US); Jorgen JC Bocklage, Bradenton, FL (US); William Evans Savage, Arlington, VA (US)

Correspondence Address: MERCHANT & GOULD PC, P.O. BOX 2903, MINNEAPOLIS, MN, 55402-0903, US

(21) Appl. No.: 12/055,683

(22) Filed: Mar. 26, 2008

Related U.S. Application Data
(60) Provisional application No. 60/919,991, filed on Mar. 26, 2007.

(51) Int. Cl. G06Q 40/00

(52) U.S. Cl. 705/37; 705/38

(57) ABSTRACT

A system and method that provide for fluid financial markets are disclosed. One system includes an issuing module that issues a credit account to a consumer based on a rating and tied to a credit bank. The system also includes an update module that updates the rating over time based on financial factors related to the consumer. The system includes a financial module that allows the credit bank to change over time based on the rating.

### CROSS REFERENCE TO RELATED APPLICATIONS

The present application claims priority to U.S. Provisional Patent Application No. 60/919,991, filed Mar. 26, 2007. The entire disclosure of that application is hereby incorporated by reference in its entirety.

### TECHNICAL FIELD

The present invention relates generally to the field of financial and data transaction systems, and more particularly to a system and method of providing for fluid financial markets.

### BACKGROUND

Many consumers have credit cards. The most common of these are credit cards carrying the Visa or MasterCard logos. If a consumer desires to have a credit card bearing the Visa or MasterCard logo, the consumer typically goes to a bank. The bank typically offers several such credit cards to serve a variety of credit conditions for its consumers. For example, one consumer might qualify for a standard Visa card having a credit limit of between $100 and $3000. Another consumer might qualify for a gold visa card having a credit limit of between $3000 and $10,000. The consumer applies for the particular credit card she is interested in. The bank will evaluate the credit application to determine if the consumer qualifies for the credit card. If the consumer does not qualify, the bank will reject the consumer's credit card application. If the consumer does qualify, the bank will issue the credit card with a credit limit and according to standard terms and conditions, such as the interest rate.

Such credit card applications and issuances have disadvantages. One such disadvantage is that the consumer must apply to a particular bank and accept that bank's terms. If the bank rejects the consumer, the consumer can apply at another bank. Another disadvantage is that the consumer must shop for the best credit card deals amongst competing banks. One bank might offer a lower interest rate or a higher credit limit than another bank. Another disadvantage is that the credit relationship between the bank and the consumer is usually fixed. The credit limit and the interest rate may be adjusted by the bank, but otherwise the relationship with that bank continues unless the consumer decides to reapply for a new card at another bank. Another disadvantage is that the bank is tied to the consumer and either must carry the consumer or close the account.

Therefore, improvements are desirable.

### SUMMARY

In accordance with the following disclosure, the above and other problems are solved by the following:

In a first aspect, a system that provides for fluid financial markets is disclosed. The system includes an issuing module that issues a credit account to a consumer based on a rating and tied to a credit bank. The system also includes an update module that updates the rating over time based on financial factors related to the consumer. The system includes a financial module that allows the credit bank to change over time based on the rating.

In a second aspect, a method that provides for fluid financial markets is disclosed. The method includes issuing a credit account to a consumer, based on a rating assigned and associated with a first financial entity holding the account receivable. The method further includes updating the rating over time based on financial factors related to the consumer, and communicating the updated rating to a plurality of financial entities. The method also includes receiving at least one offer to hold the account receivable based on the updated rating, and selecting the offer and associating the credit account to a new financial entity based on the offer.

In a third aspect, a further method that provides for fluid financial markets is disclosed. The method includes soliciting bids for consumer terms relating to a credit account, and selecting a set of consumer terms from the bids. The method further includes soliciting bids for incentive terms relating to the credit account based on the set of consumer terms, and selecting a set of incentive terms relating to the credit account, the set of incentive terms relating to a credit bank. The method also includes associating an account receivable for the credit account with the credit bank.

### BRIEF DESCRIPTION OF THE DRAWINGS

Referring now to the drawings in which like reference numbers represent corresponding parts throughout:

FIG. 1 is an exemplary embodiment of a schematic representation of methods and systems for fluid financial markets;

FIG. 2 is an exemplary embodiment of a schematic representation of a computing system that may be used to implement aspects of the present disclosure;

FIG. 3 is an exemplary embodiment of a schematic representation of the entities of a financial relationship;

FIG. 4 is an exemplary embodiment of a process flow diagram illustrating a method for fluid financial markets;

FIG. 5 is an exemplary embodiment of a schematic representation of methods and systems for financial program formation in fluid financial markets;

FIG. 6 is an exemplary embodiment of a schematic representation of methods and systems for processing individual program applications in fluid financial markets;

FIG. 7 is an exemplary embodiment of a schematic representation of methods and systems for categorizing applications in fluid financial markets;

FIG. 8 is an exemplary embodiment of a schematic representation of methods and systems for categorizing and processing individual applications in fluid financial markets;

FIG. 9 is an exemplary embodiment of a schematic representation of methods and systems for bidding on consumer terms in fluid financial markets;

FIG. 10 is an exemplary embodiment of a schematic representation of methods and systems for a further method of bidding on consumer terms in fluid financial markets; and

FIG. 11 is an exemplary embodiment of a schematic representation of methods and systems for bidding on incentive terms in fluid financial markets.

### DETAILED DESCRIPTION

Various embodiments presented herein will be described in detail with reference to the drawings, wherein like reference numerals represent like parts and assemblies throughout the several views. Reference to various embodiments should not be construed as limiting the scope of covered subject matter, which is limited only by the scope of the claims attached hereto. Additionally, any examples set forth in this specification are not intended to be limiting and merely set forth some of the many possible embodiments.

In general the present disclosure relates to methods and systems that provide for fluid financial markets, and in particular to providing for fluid financial markets for credit accounts, such as revolving credit accounts. A central entity maintains relationships with merchants for accepting charges, with settlement banks for paying merchants, with issuing banks for issuing credit cards, with financing banks for financing the account receivables, and with consumers for providing credit. The methods and systems described herein allow financial entities, such as banks, to buy and sell accounts receivable for credit accounts in a fluid market, similar to the stock market. The financial entities can receive a listing of account ratings on an ongoing basis and can sell off credit accounts not desired and purchase credit accounts desired. Because there are millions and millions of consumers and credit accounts, and because there are thousands and thousands of financial entities, all having different criteria for accounts, the credit accounts can be bought and sold regularly on an individual basis. In addition, the methods and systems described herein allow a consumer one point of entry to the credit market. As, the consumer's credit worthiness fluctuates, the financial entities respond with new terms and conditions while the consumer maintains the initial relationship with the central entity. The central entity can offer programs and can categorize incoming applicants, allowing banks to bid on accounts receivable based on the creditworthiness of a type of account or an individual account.

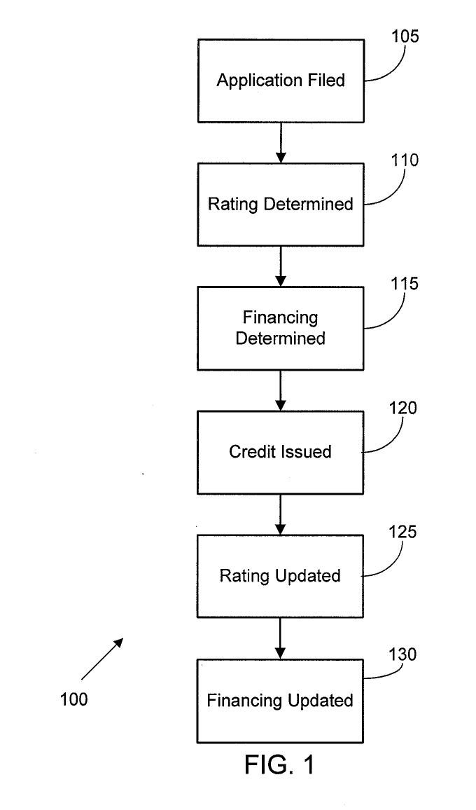

Referring now to the Figures, FIG. 1 depicts a block diagram representing a method and system 100 that provides for fluid financial markets. A credit module 105 receives a credit application. If a consumer desires a credit account, the consumer typically applies for credit either by written form or by electronic form, such as over the Internet. Based on the credit application and any other related information, a rating module 110 determines a rating for that consumer. The rating might be a standard credit rating or score, or may be a rating or score determined by the system 100 based on various criteria.

Based on the rating, a financing module 115 determines financing for the consumer's credit account. Typically, this involves finding financing for the credit account from a number of member banks. Any number of banks might offer to hold the accounts receivable for the credit account. A credit module 120 issues credit to the consumer. An update module 125 updates the consumer's rating over time. This rating might be updated based on a number of factors such as income, credit worthiness, payment history, revolving balance, and other factors. Because the rating can change over time, the financing may also change over time. As such, a financing module 130 updates the financing of the credit account. For example, as the rating increases, other banks might offer to hold the accounts receivable for the credit account with different terms. As such, a new bank might be selected to hold the account receivable. The same could be true if the rating decreases, other banks might offer to hold the account receivable.

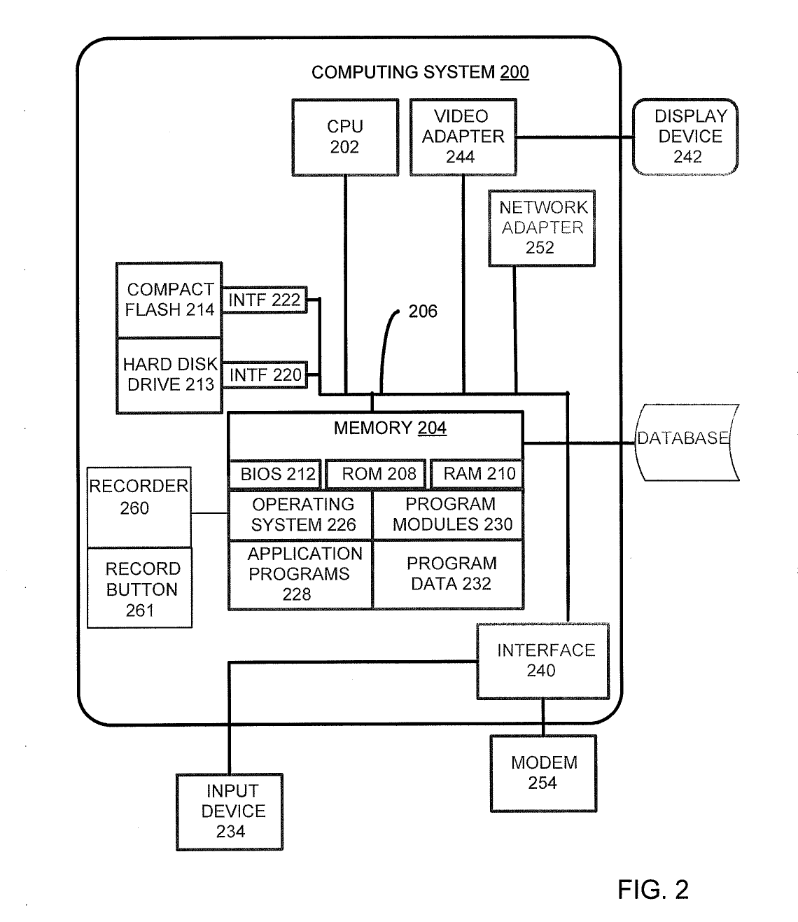

FIG. 2 and the following discussion are intended to provide a brief, general description of a suitable computing environment in which the invention might be implemented. Although not required, the invention is described in the general context of computer-executable instructions, such as program modules, being executed by a computing system. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

Referring now to FIG. 2, an exemplary environment for implementing embodiments of the present invention includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

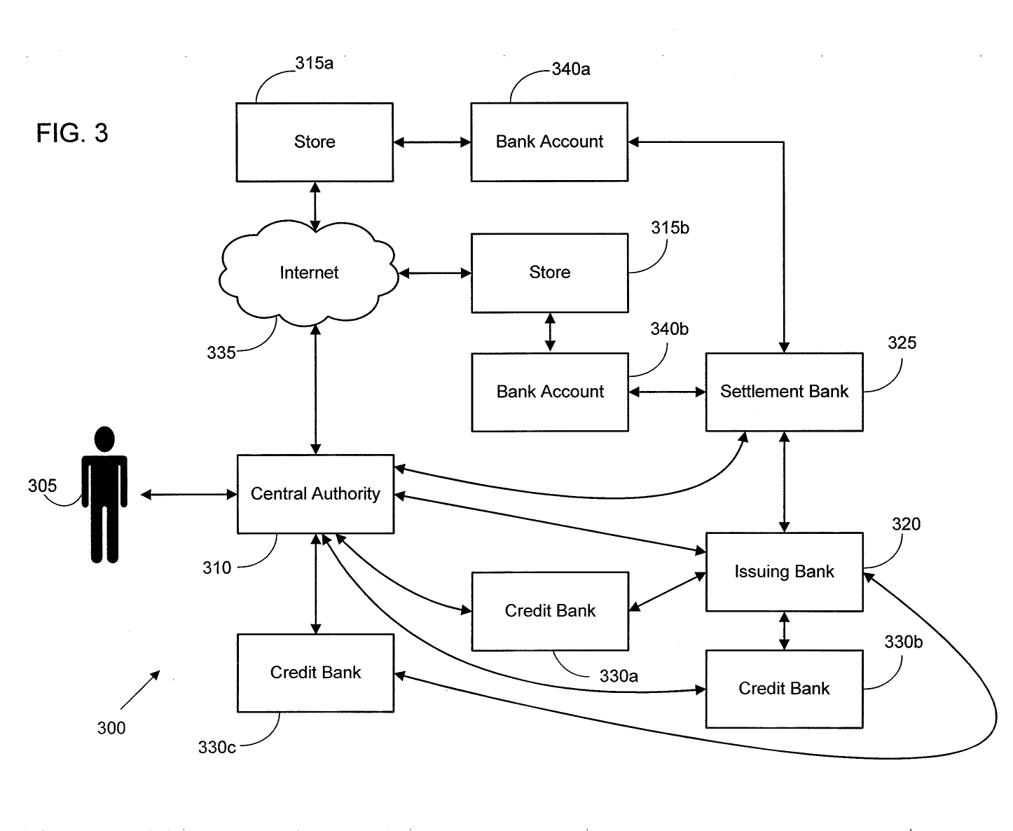

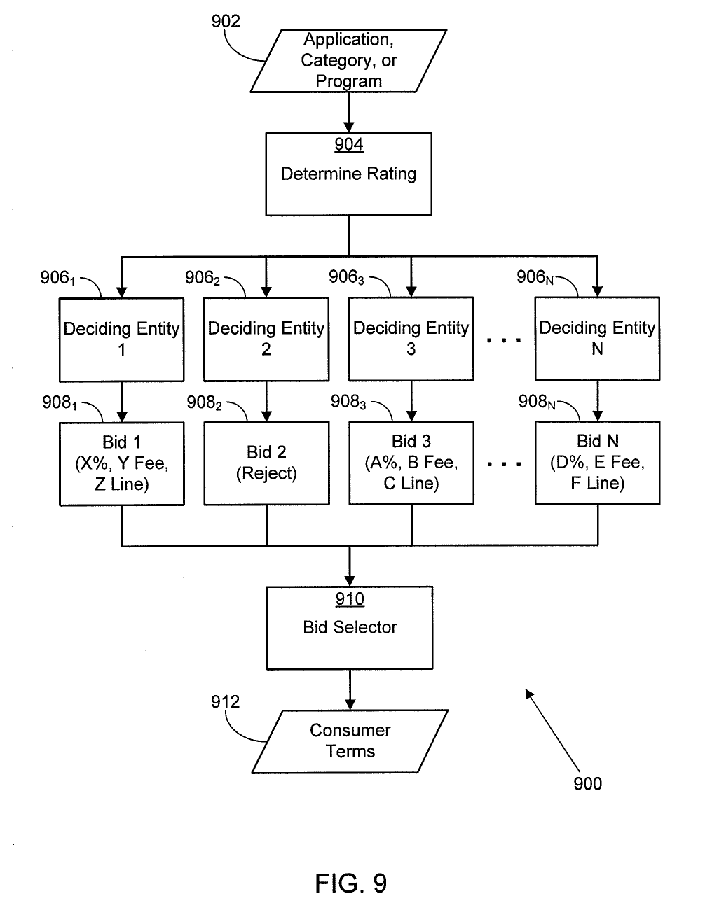

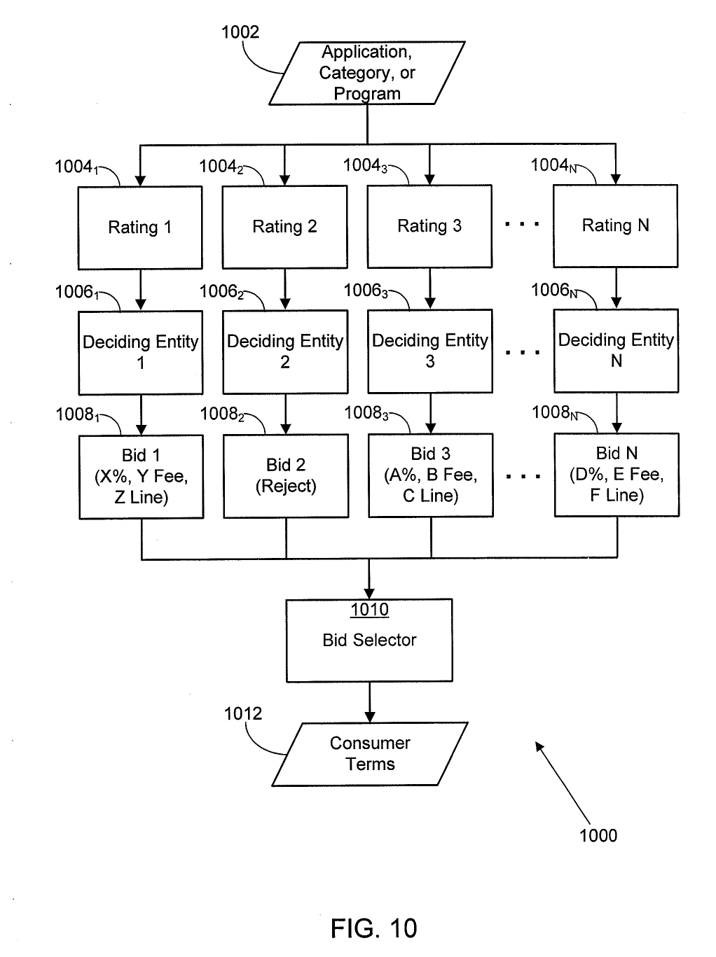

FIG. 3 is a block diagram representing a financial arrangement 300. In general, the financial arrangement preferably includes a consumer 305, a central authority, or entity, 310, a plurality of merchants 315 (e.g. the stores 315a-b), an issuing bank 320, a settlement bank 325, and a plurality of credit banks 330. Typically, the consumer 305 applies for a credit account to the central authority 310. The central authority 310 evaluates the credit application, and other information, of the consumer 305 and determines a rating. The central authority 310 communicates the rating to the issuing bank 320. The issuing bank 320 in turn communicates the rating to the credit banks 330. In one possible embodiment, the central authority could communicate the rating to the credit banks 330 directly. In another possible embodiment, the issuing bank 320 or the credit banks 330 might evaluate the credit application and determine the rating, as described in FIG. 9-10, below.

The credit banks 330 will offer to hold the account receivable for the credit account at certain terms and conditions. It is anticipated that the arrangement 300 will include a large number of credit banks 330 such that multiple offers will be communicated with varying terms and conditions. A credit bank 330 will be selected to hold the accounts receivable for the consumer 305 and a credit account will be issued by the issuing bank 320 to the consumer 305. The credit bank 330 might be selected based on the best terms and conditions for the consumer 305, such as the lowest interest rate. In another possible embodiment, the credit bank 330 might be selected based on the financial arrangement to the central authority 310, such as the fee to be paid to the central authority in exchange for awarding the account receivable to the credit bank 330.

The consumer 305 then uses her credit account to make purchases at various merchants 315, including vendors, of products and/or services. Preferably, the merchant 315 communicates with the central authority 310 via the Internet 335 for authorization and to provide the details of the transaction. The central authority 310 in turn communicates with the issuing bank 320. The issuing bank 320 communicates with the settlement bank 325. In one possible embodiment, the central authority communicates directly with the settlement bank 325. The settlement bank 325 credits the bank account 340 of the store 315 for the approved amount. The issuing bank 320 communicates with the credit bank 330 to debit the credit account of the consumer 305.

In certain embodiments, the credit banks 330 rely on the issuing bank 320 to receive funds from the consumer 305, in that the consumer has an established contractual obligation with the issuing bank 320. In still another possible embodiment, one of the credit banks 330 can act as the issuing bank 320, and therefore has the legal right to collect funds owed by the consumer.

The rating of the consumer 305 can change over time. This may be due to change in income, purchase history, payment history, revolving line of credit balance, or other factors. One or more of the factors may be evaluated in the rating. However, as the rating changes, either up or down, the credit bank 330 might be interested in changing the terms and conditions it has with the consumer 305. In addition, other credit banks 330 might wish to offer to hold the accounts receivable of the consumer 305. As such, the central authority 310 can change the credit bank 330 to a new credit bank 330 without the consumer 305 needing to reapply or change credit cards.

In embodiments where the credit bank 330 acts as the issuing bank 320, the central authority 310 can contract with the credit bank 330 to establish a time-limited or conditioned right to remain the issuing bank and to hold a right to the accounts receivable from the consumer 305. In such systems, when the credit bank 330 and possibly the issuing bank 320 changes, a new card may be issued to the consumer 305.

This arrangement 300 has numerous advantages. One such advantage is that the consumer 305 has only a single point of entry to the arrangement 300. As such, the consumer 305 need only make one credit application to the central authority 310, and the central authority 310 will determine multiple credit relationships for the consumer both at the initial application process and as an ongoing process over time. As the consumer's 305 rating goes up and down, the terms and conditions of the credit account can change and the credit bank 330 holding the accounts receivable can change. For example, if the consumer's 305 rating goes up, the consumer can automatically receive a higher credit limit and a lower interest rate from a new or existing credit bank 330 without the consumer needing to reapply. In previous systems, the consumer 305 would have to call the bank to ask for a better deal or shop around to new banks for a new credit account. In the arrangement 300 shown in FIG. 3, this is eliminated. If the consumer's 305 rating goes down, the consumer can automatically receive a lower credit limit and a higher interest rate from a new or existing credit bank 330 without the consumer 305 needing to reapply. In previous systems, the consumer 305 may have had her account cancelled or just have received notice about a new higher interest rate.

Another such advantage is that the credit banks 330 have a fluid market in which to buy and sell accounts receivable. As a consumer's 305 rating changes, a particular credit bank 330 might wish to acquire the consumer's 305 account receivable or sell the account receivable. For example, if a consumer 305 initially had a high rating, the consumer 305 was desirable to the credit bank 330. If the consumer's 305 rating falls below some threshold, the consumer 305 may no longer be desirable to the credit bank 330. In the arrangement 300, the credit bank 330 is able to offload the account receivable to another credit bank 330 offering to hold the account receivable. The same could be true if the consumer 305 initially had a low rating, but her rating is increasing.

In general, credit banks 330 hold assets of varying credit worthiness. Some banks specialize in serving consumers 305 with high ratings. The risk associated with such consumers 305 is lower, as is the return on the accounts receivable. Other banks might specialize in serving consumers 305 with lower ratings. The risk associated with such consumers 305 is higher, as is the return on the accounts receivable. As such, as a consumer's 305 rating is adjusted up or down, the consumer 305 may move into or out of favor with any particular bank.

It is noted that while FIG. 3 includes a settlement bank 325, an issuing bank 320 and credit banks 330, there could be multiple banks and any of the banks could perform any of the operations described herein in conjunction with other operations. Furthermore, one or more banks can perform one or more of the functions described as relating to the settlement bank 325, the issuing bank 320, and the credit banks 330.

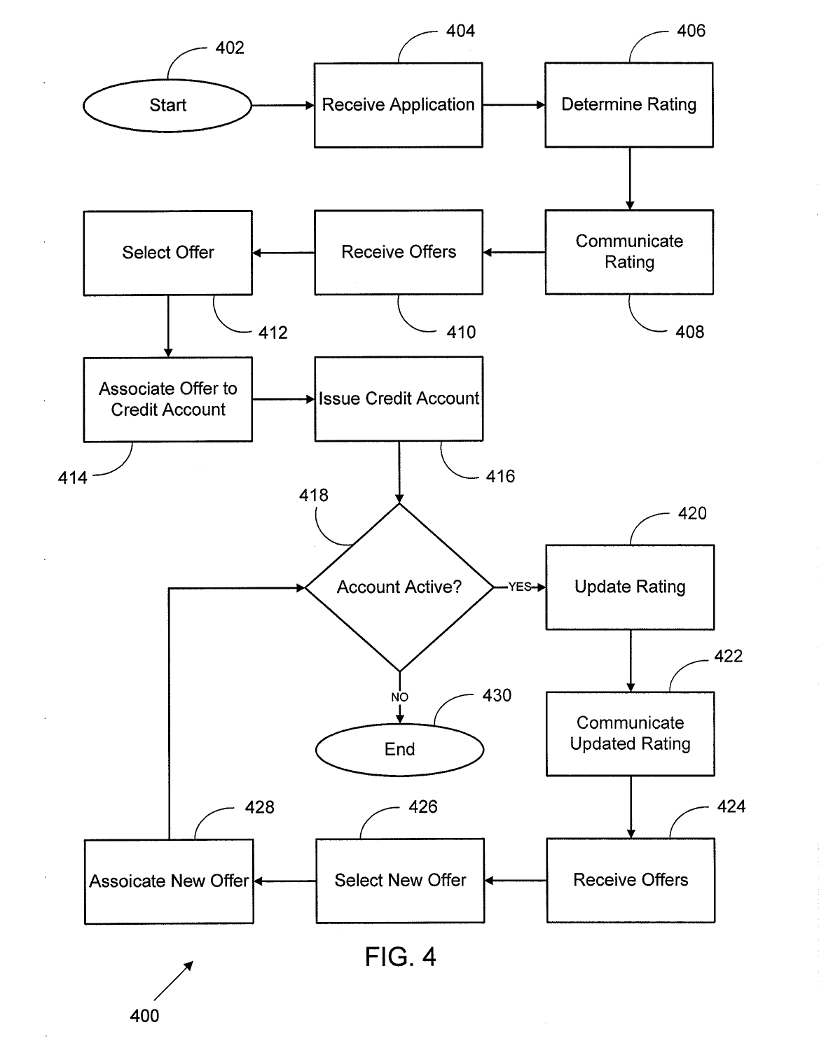

FIG. 4 is an exemplary process flow diagram for a fluid financial market system 400. The flow process starts at instantiation 402. A receive operation 404 receives credit application information. The credit application information, itself, may include the information typically necessary to conduct a credit check, in order to determine the credit worthiness of an individual. For example, such information may include identifying information, such as the name, address, telephone number, and/or social security number of the applicant, and may also include employment information such as place of business, number of years worked at such place of business, etc. Such information may include health information, emergency contact information, family information, etc. (these other forms of information are discussed below). If the application is ultimately approved, other types of information may be collected from the applicant/cardholder at a later time.

A determine operation 406 determines a rating for the applicant based on an evaluation of the application. According to some embodiments, a credit check may be performed upon the applicant. The application information may include a sufficient quantity of information to query a credit score service (example: Fair Isaac Co.) to obtain a credit score for the individual (example: FICO score). If the credit score exceeds a particular threshold, then the application is approved, otherwise it is declined. According to other embodiments, the applicant's application information is communicated via a network such as the Internet to one or more card-issuing banks, such as bank 320 of FIG. 3. Each card-issuing bank can individually use the application information to perform its own analysis and independently conclude whether to deny or approve the application. The rating, or score, might be the credit score of the application or it might be some other rating or score.

A communicate operation 408 communicates the rating from the determine operation 406 to a plurality of financial entities, such as banks 330 of FIG. 3. The financial entities evaluate the rating and determine if they want to make an offer to hold the account receivable. A receiver operation 410 receives the offers from the financial entities desiring to be associated with the consumer, such as the consumer 305 of FIG. 3. The financial entities that desire to hold the accounts receivable of the consumer send offers having certain terms and conditions, which may include compensation terms for the central authority. Based on these terms and conditions, a select operation 412 selects an offer. An associate operation 414 associates the offer to the credit account, such that the credit account is associated with a particular financial entity that will hold the account receivable. An issue operation 416 issues the credit account to the consumer. The issue operation 416 might be performed by an issuing bank, such as issuing bank 320 of FIG. 3.

According to some embodiments, the select operation 412 compares the credit terms offered by the financial entities, and selects the financial entity offering the best credit terms as the financial entity associated with the credit account. According to other embodiments, each financial entity might communicate a bid, e.g., a monetary sum it is willing to pay to a central authority, such as the central authority 310 of FIG. 3, to acquire the account, and the select operation 412 might select the financial entity offering the highest bid, for example. According to other embodiments, more than one financial entity might be associated with the credit account, and the consumer is permitted to select from among the financial entities for extension of credit, with each purchase.

According to further embodiments, the associate operation 414 associates the credit account with a financial entity for a limited time. In these embodiments, the credit account is in effect “leased” to the financial entity for the limited time. This can be accomplished via a time-restricted license to the financial entity, or via a contract assigning the right to the accounts receivable for the credit account that is subject to a time-related obligation reassignment back to the central authority. Other possibilities exist as well.

In still further embodiments, the associate operation 414 enables the financial entity to become an issuing bank for the credit account. In such embodiments, the limited time right to own the accounts receivable relating to the account is generally established via a contract assigning the right to the accounts receivable for the credit account that is subject to a time-related obligation reassignment back to the central authority.

In certain further embodiments, the receiver operation 410 and the select operation 412 are performed in more than one offer operation, such as a multiple-round bid process. Example systems that can be incorporated into and can execute the receiver operation 410 and the select operation 412 are described below in conjunction with FIGS. 9-11.

An active operation 418 determines if the account is active. If the active operation 418 determines that the account is not active, operation branches “NO” to an END operation 430. Alternatively, the operation could branch “NO” to the active operation 418 such that a loop is formed until the account is active. If the active operation 418 determines that the account is active, operation branches “YES” to an update operation 420. The update operation 420 updates the rating for the credit account. The rating might change for a variety of reasons. These reasons can include changes in income, payment history, credit score, revolving account balance, etc. As such, the rating can be continuously changing.

In certain embodiments, the active operation 418 corresponds to elapsing of a period of time in which a financial entity is associated with a credit account. For example, the active operation 420 can cause the system to update the rating of the credit account every six months to a year.

A communicate operation 422 communicates the updated rating to the financial entities. A second receive operation 424 receives new offers from financial entities desiring to acquire the account receivable of the credit account. These financial entities might desire to acquire the account receivable based on the new rating (e.g. using the bidding processes described in conjunction with this figure or FIGS. 9-11). For example, the rating might now fall within a range of desired accounts for that financial entity and, the rating might have fallen out of a range desired by the associated financial entity.

A second select operation 426 selects a new offer, similar to the first select operation 412. An associate operation 428 associates the new financial entity to the credit account. Operational flow branches to the account operation 418 and operational flow proceeds as previously described.

In certain embodiments, the associate operation 428 operates without regard to the current entity holding a right to the account receivables of the credit account. In further embodiments, the associate operation 428 allows the current entity a right of first refusal to retain the account receivables of the credit account based on the new rating and at new terms, as set and selected in the second select operation 426. In still further embodiments, the associate operation 428 allows the new financial entity to transmit a portion of fees paid for the right to the accounts receivable (i.e. a bounty or basis points as described below) to the current entity to offset the loss of the accounts receivable.

The above is probably best understood by way of application examples. Referring to FIGS. 3 and 4, a consumer 305 wishes to receive a credit card, according to one example embodiment. The consumer 305 fills out a credit card application with the central authority 310. The receive operation 404 receives the credit card application. The determine operation 406 determines a rating for the consumer 305, such as a score of 207. The rating could be determined by the issuing bank 320 or the central authority 310 based upon some agreed upon criteria within the financial arrangement 300.

The communicate operation 408 communicates to the credit banks 330 that a consumer 305 with a score of 207 wishes to receive a credit card. Several credit banks 330 respond with offers to hold the account receivable for this consumer 305. A first credit bank 330a offers $50 to the central authority 310 and an interest rate of 8% to the consumer 305. A second credit bank 330b offers $25 to the central authority 310 and an interest rate of 7%. The select operation 412 selects credit bank 330b because the interest rate of 7% is the best deal for the consumer 305. The associate operation 414 associates the account receivable to credit bank 330b. The issuing bank 320 issues the credit card to the consumer 305 at 7% interest. Alternatively, the select operation 412 could select credit bank 330a because the $50 to the central authority 310 is a better deal for the central authority 310.

The consumer 305 uses the credit card at store 315a to charge $200. The central authority 310 approves the charge and informs the settlement bank 325. The settlement 325 credits the bank account 340a of the store 315a $200. The central authority 310 also informs the issuing bank 320 and the credit bank 330b who debit the account receivable of the consumer 305. When the consumer 305 receives her credit card statement, she immediately pays the minimum payment and carries a balance over.

The active operation 418 determines that the account is active and branches “YES” to the update operation 420. The update operation 420 updates the rating, previously 207, to a rating of 240. In this example, the rating was increased because the consumer 305 paid right away and carried a balance forward, such that the credit bank 330b is making money off the interest. The second communicate operation 422 communicates the updated rating of 240 to the credit banks 330. The receive operation 424 receives a new offer from a different credit bank for an interest of 6%. The second select operation 426 selects the new credit bank 330c, and the associate operation 428 associates the new credit bank 330c at 6% interest to the account receivable. The consumer 305 still holds the same credit card, but now has a relationship with a new credit bank 330c holding the account receivable. The consumer 305 might receive her statement from the new credit bank 330c new month.

Returning to the update operation 420 and assuming the consumer 305 missed her payment date by 10 days, the update operation 420 updates the rating, previously 207, to 187. The second communicate operation 422 communicates the new rating of 187 to a plurality of credit bank 330. In this example, receive operation 424 receives a new offer from credit bank 330c at 10% interest and the existing credit bank 330a rescinds its previous offer. The select operation 426 selects the new credit bank 330c, and the associate operation 428 associates the account receivable with the new credit bank 330c. In this manner, the existing credit bank 330a was able to offload an account it no longer desired to the new credit bank 330c. In existing systems, old credit bank 330a would have had to choose between terminating the account of the consumer 305, or accepting a below market interest rate for a consumer 305 with a rating of 187.

In certain of the examples, the new credit bank 330c can pay a bounty or basis points to the central authority, with a portion of that bounty or basis points sent to the old credit bank 330a as an offset for losing the credit account.

In the above application examples, it is clear that the methods and systems herein are advantageous to all of the parties of the financial relationship 300. In particular, consumers can receive improving interest rates and other financial terms as their credit improves. Credit banks receive up to date credit information about consumers. Issuing banks and the central authority can re-monetize the accounts, generating new revenue streams.

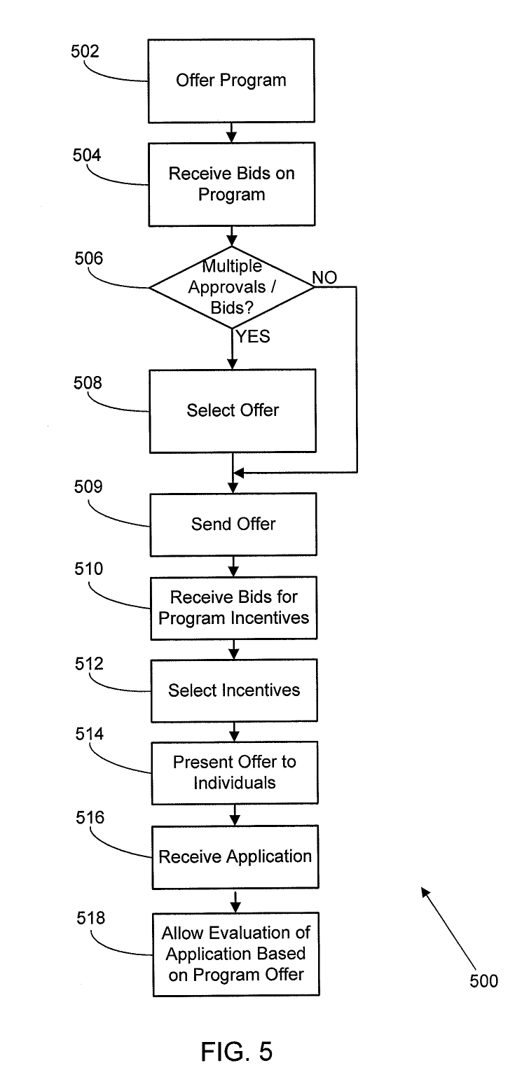

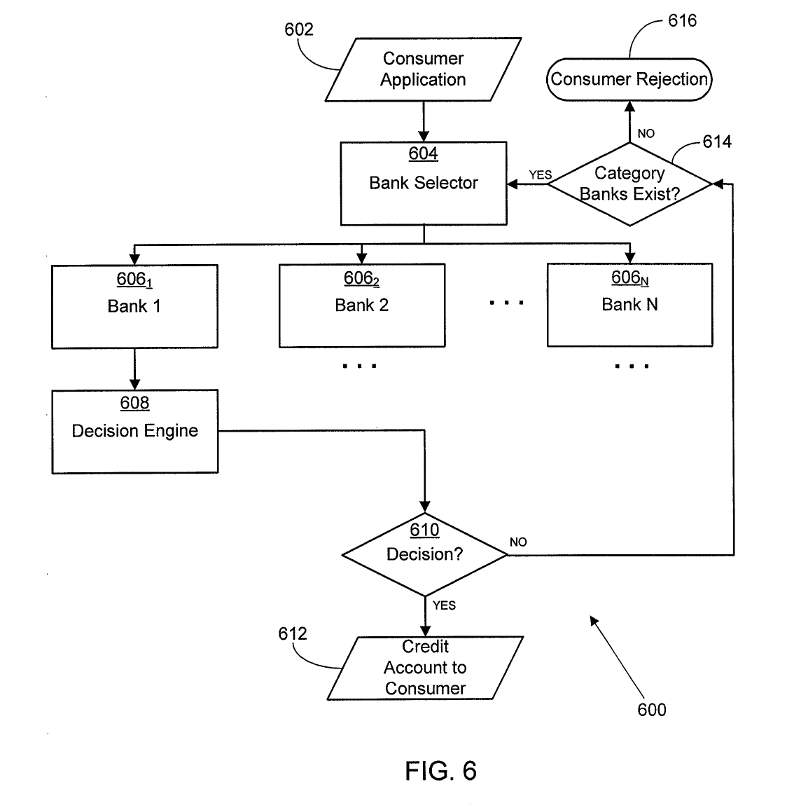

Referring now to FIGS. 5-6, application of similar principles can be made with respect to a program offered by a central authority or issuing bank. FIG. 5 is an exemplary embodiment of a schematic representation of methods and systems 500 for financial program formation in fluid financial markets. In the methods and systems 500 described herein, financial programs correspond generally to offered incentives by an issuing bank, a central authority, or other entity described above in FIG. 3 with respect to retailer incentives or other rewards presented to a consumer to induce consumers to open an account (e.g. a line of credit) to receive the incentive. For example, the program could be a cash back program, a percentage discount at a retailer, or a product reward incentive. Other incentives could be offered to a consumer as well.

An offer module 502 corresponds to an offer of a program to one or more credit issuing institutions, such as the credit banks 330 of FIG. 3. The offer module 502 distributes the terms of the program to the various credit banks such that the credit banks can assess the terms of the offer and indicate financial terms that those banks are willing to provide to consumers relating to the program.

A bid receipt module 504 receives bids from those credit banks that choose to offer to extend credit to consumers according to the program, from among the various credit banks to which the program was offered by the offer module 502. The credit banks may choose to offer certain consumer credit terms for the program, or may decline to offer credit according to the terms of the program. The credit terms that are bid by credit banks include, for example, a credit line to be issued to consumers for a credit account, an interest rate to charge consumers on outstanding balances relating to the credit account; or an annual fee to be charged to a consumer for use of a credit account. Other consumer credit terms may be incorporated into the received offers as well. Furthermore, preliminary incentives to the central authority may be included with the consumer credit terms as well. Details regarding incentives are described in conjunction with the program incentive bidding module 510 and the incentive selection module 512, below.

A bid consideration operation 506 determines whether multiple bids have been received from credit banks based on the program to be offered. If multiple bids are received, operational flow branches “yes” to an offer selection module 508. If one bid is received, operational flow branches “no” to a send offer module 509. Furthermore, if the bid consideration operation 506 determines that no bids are received, operational flow is terminated within the method and system 500.

The offer selection module 508 selects the offer terms relating to the consumer, and such selection may be based to ensure that consumers obtaining credit cards in accordance with the offer receive the most advantageous credit terms. This generally corresponds to selecting a set of credit terms with the overall lowest fee burden on a consumer based on interest rates and annual fees, while maximizing the credit line that can be extended to a consumer.

The send offer module 509 sends the winning offer's customer terms, as determined by the offer selection module 508 (or as a result of being the only offer received, as determined by the bid consideration operation 506), to one or more credit banks. The credit banks are intended to bid on incentives that those banks would provide to the issuing bank or central authority to obtain accounts receivable relating to a credit account having the customer terms specified for the program.

A program incentive bidding module 510 receives bids for program incentives to be provided to the central authority or other coordinating entity from whom credit applications are received. One or more credit banks are provided with information relating to the credit terms by the send offer module 509. The bids, in this instance, are bids relating to incentives to the central authority and include, for example, basis points (e.g. a portion of the interest collected by the credit bank) or a “bounty” represented by a fee paid by the credit bank to the central authority. The bids represent the basis points and/or bounty offered to the central authority for the right to issue credit to applicants in accordance with the winning bid selected by the offer selection module 508.

An incentive selection module 512 selects the incentive associated with the bid that provides the best terms for the central authority. The incentive selection module 512 can adjust to select the “best” combination of a bounty or basis points for use, in combination with the credit terms relating to consumers. The “best” central authority incentives may vary as the requirements of the central authority change; therefore, the incentive selection module 512 may select one or more bids having different incentives for the central authority (with the consumer terms remaining substantially constant).

At this point, one or more credit banks are approved to (and have agreed to) issue credit to customers qualifying for the program offered by the central authority. An offer presentment module 514 presents an offer to a consumer from the central authority. The offer contains the consumer terms, and is tied to one of the bids from the selected credit banks. The offer corresponds to an offer of the program to one or more consumers. An application receipt module 516 receives an application from one or more consumers, in response to an offer presented to the consumers by a central authority or an issuing bank. An application evaluation module 518 evaluates individual applications for acceptance in the program offered by the central authority. Some example methods and systems for processing applications in the application evaluation module 518 are described in conjunction with FIG. 6, below.

Now referring to FIG. 6, an exemplary embodiment of a schematic representation of methods and systems 600 for processing individual program applications in fluid financial markets is illustrated. The methods and systems 600 relate to processing a particular credit application received in response to a program offer broadcast to a number of potential consumers. A consumer application 602 is received in the methods and systems 600, and includes information about the consumer, including name, age, income level, payment history, social security number, bank account information, or other information.

The consumer application 602 is received at a bank selector module 604, which selects one of a plurality of banks that were previously selected as credit banks to issue credit to the consumer in accordance with the program offered by the central authority or issuing bank. The bank selector module 604 selects a bank 606 based on desired incentive terms for the central authority and/or issuing bank at the time the consumer application is received. In the embodiment shown, banks 606_{1-N} were previously approved to issue credit accounts in accordance with the program, and are available to be chosen by the bank selector module 604. Each of the banks 606_{1-N} generally offer substantially similar credit terms for the consumer, but may offer different incentive terms for selection by the central authority, based on the needs of the central authority or issuing bank.

A bank 606 (in this case “Bank 1” 606₁) receives the consumer application 602, and routes the application to a decision engine 608 associated with that bank. In general, each bank 606 has associated with it a decision engine 608 which determines whether the bank will issue an account to a user based on the contents of the application. As illustrated in conjunction with a financial program offer, the decision engine determines whether the bank should issue a credit account to the user in accordance with the previously-bid consumer terms and incentive terms, such as would be arrived at via the bidding processes described above in FIG. 5.

A decision determination operation 610 determines whether the decision engine 608 resulted in an offer of a credit account based on the application and the program and incentive terms. If the decision engine 608 determines that a credit account is to be issued, the decision determination operation 610 causes operation to branch “yes”, resulting in issuance of a credit account 612 to the consumer, such as by issuing a credit card to the consumer. Following operation of the methods and systems 600, the newly-established credit account can be continually (or periodically) monitored and evaluated to improve credit terms for the consumer, the issuing bank, and the central authority, using methods analogous to those described above in conjunction with FIG. 4.

If the decision engine 608 determines that a credit account should not be issued, the decision determination operation 610 causes operation to branch “no” to a bank reselection operation 614. The bank reselection operation 614 considers whether additional banks exist among the banks 606_{1-N} that have not specifically denied credit to the consumer based on the application 602. If additional banks exist which have not previously rejected the consumer application 602, operational flow branches “yes” to the bank selector module 604 to select a new bank which has not previously considered the application for consideration and possible issuance of a credit account. If no additional banks exist (e.g. all approved credit banks have denied the consumer application), operational flow branches “no” to a customer rejection operation 616, which corresponds to an overall rejection of the customer application for issuance of a credit account relating to the program and at the prenegotiated terms.

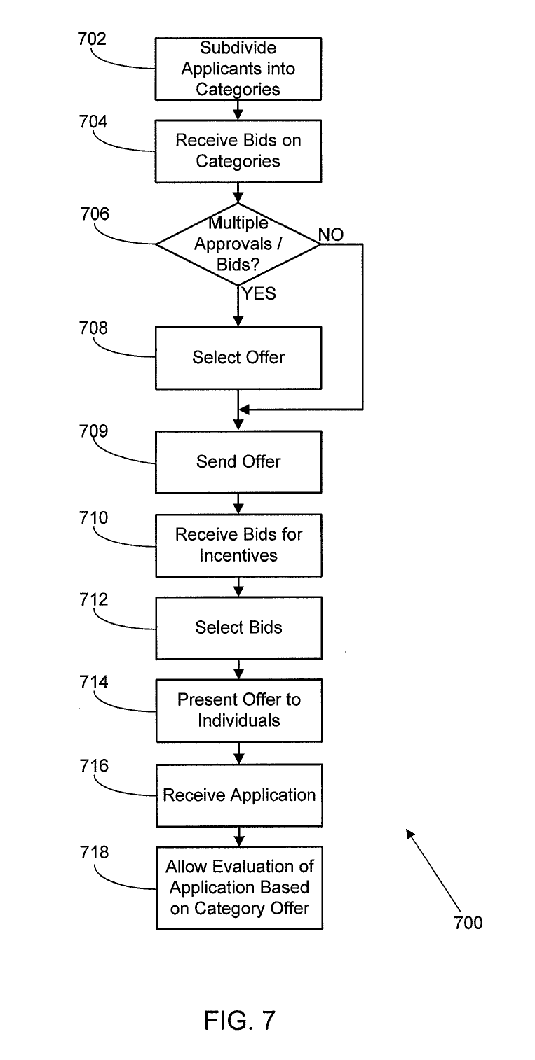

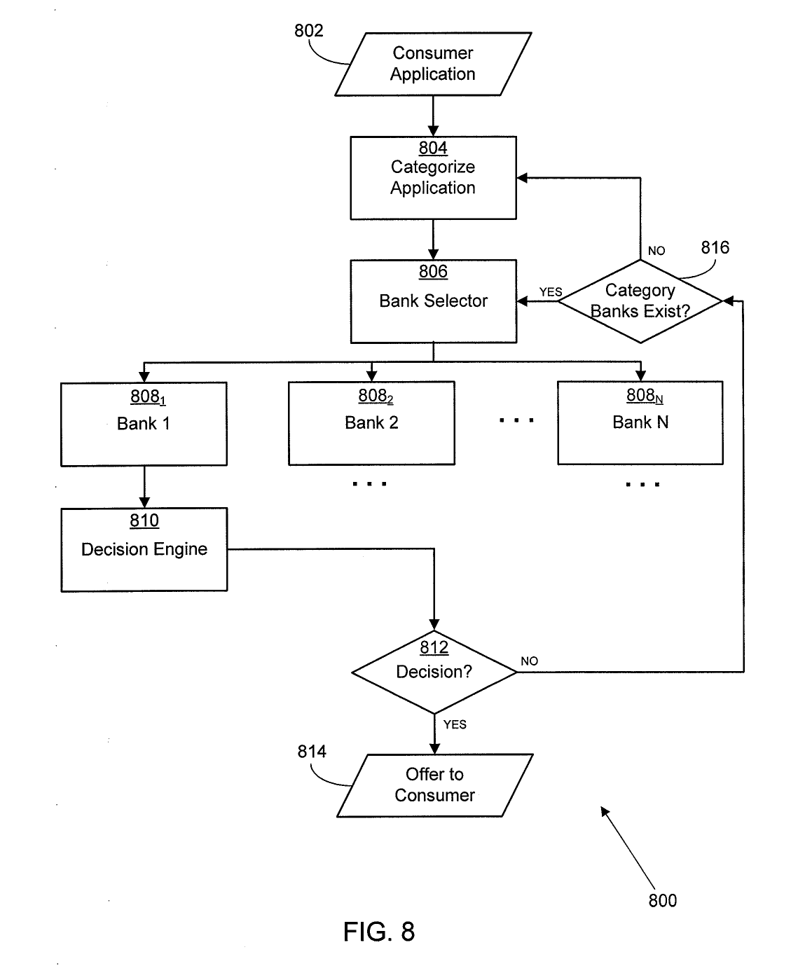

Referring now to FIGS. 7-8, application of similar principles can be made with respect to categorized applications received by a central authority or issuing bank. FIG. 7 is an exemplary embodiment of a schematic representation of methods and systems 700 for categorizing applications in fluid financial markets. Categorization, as referred to in these figures, relates generally to grouping of applications by overall expected desirability to a credit bank, such as based on a credit rating, income, or other desirability-based characteristic. The methods and systems 700 include an applicant categorization module 702, which defines one or more categories of credit applications to be offered to credit banks for bidding. The categories can be based on a rating system defined in the applicant categorization module, or can be based on external rating, such as a credit rating or other criteria.

A bid receipt module 704 receives bids on one or more of the categories defined by the applicant categorization module 702. The bids received by the bid receipt module 704 relate to customer credit terms, such as an interest rate, credit line, annual fee, and other customer credit terms. A bid consideration operation 706 determines whether multiple bids have been received from credit banks based on the categories to be offered. If multiple bids are received, operational flow branches “yes” to an offer selection module 708. If one bid is received, operational flow branches “no” to a send offer module 709. Furthermore, if the bid consideration operation 706 determines that no bids are received, operational flow is terminated within the method and system 700.

In certain embodiments of the methods and systems 700 described herein, a bid (such as received by the bid receipt module 704 or the incentive bidding module 712, below) can include a percentage of individuals falling within the defined category that the credit bank will agree to approve of when individual applications are routed to that bank (as in FIG. 8, below). In such embodiments, the incentive provides some reliability for the central authority or issuing bank to ensure that at least a baseline percentage of applicants categorized within a certain category will in fact receive credit accounts, resulting in receipt of the incentives by the central authority or issuing bank.

The offer selection module 708 selects an offer from among the offers received for each of the categories defined in the applicant categorization module 702. the offer selection module 708 selects an offer for each category that has the best terms for the applicants falling into each category. As with the offer selection module 508 of FIG. 5, the offer selection module 708 selects a set of consumer terms, possibly including an interest rate, credit line, annual fee, and/or other terms for each category. It is noted that the offer selection module 708 will likely select different sets of consumer terms for each category of applicants, because different categories of applicants will have different desirabilities to credit banks. For example, a category of individuals having a low credit rating and low income may generally be less desirable than a category of high income, high credit rating individuals. However, based on currently business conditions, the opposite may be true (i.e. a higher risk group may be seen as more desirable, and certain consumer terms, such as rates and fees, may be adjusted accordingly).

The send offer module 709 sends the winning offer's customer terms, as determined by the offer selection module 708 (or as a result of being the only offer received, as determined by the bid consideration operation 706), to one or more credit banks. The credit banks are intended to bid on incentives that those banks would provide to the issuing bank or central authority to obtain accounts receivable relating to a credit account having the customer terms specified for the category.

An incentive bidding module 710 receives, for each category, bids for category incentives to be provided to the central authority or other coordinating entity from which credit applications are received. One or more credit banks are provided with information relating to the best credit terms per category, as selected by the offer selection module 708. The bids, in this instance, are bids relating to incentives to the central authority and also include, for example, basis points or a “bounty”. The bids represent the basis points and/or bounty offered to the central authority for the right to issue credit to applicants in accordance with the winning bid selected by the offer selection module 708.

An incentive selection module 712 selects one or more incentives associated with the winning consumer terms bid for each category that provide the best terms for the central authority. The incentive selection module 712, as with the module 512 of FIG. 5, can adjust to select the “best” combination of a bounty or basis points for use, in combination with the credit terms relating to consumers. The “best” central authority incentives may vary as the requirements of the central authority change; therefore, the incentive selection module 712 may select one or more bids having different incentives for the central authority (with the consumer terms remaining substantially constant).

At this point in the methods and systems 700, one or more credit banks are approved to (and have agreed to) issue credit to customers in each category as defined by the applicant characterization module 702. Notably, each category of applicants may have a different corresponding set of credit banks that are approved to issue credit to customers, depending on the individual credit banks' desire to offer credit to varying risk groups. At this point, individual applications are handled. An offer presentment module 714 presents a credit card offer to a possible consumer. An application receipt module 716 receives an application from one or more consumers. An application evaluation module 718 evaluates individual applications received. Some example methods and systems for processing applications in the application evaluation module 818 are described in conjunction with FIG. 8, below.

Now referring to FIG. 8, an exemplary embodiment of a schematic representation of methods and systems 800 for categorizing and processing individual applications in fluid financial markets is disclosed. The methods and systems 800 generally correspond to management of applications received by a central authority or issuing bank after credit terms for certain categories are previously negotiated, such as in the methods and systems described in FIG. 7, above.

A consumer application 802, including various consumer financial information (e.g. name, contact information, income, credit rating, social security number, and other information) is routed to a categorization module 804. The categorization module places the consumer application 802 into one of a plurality of categories defined by the central authority based on common financial characteristics. The categories can be based on a credit rating or another rating generated by the central authority and representative of the creditworthiness of the individual, such as based on bank account balances, payment histories, income, and other factors.

A bank selection module 806 selects a bank from among the banks associated with the category in which the application is placed. Based on the category in which the application 802 is placed by the categorization module 804, the bank selection module 806 can select one or more banks 808_{1-N} that have previously been approved by the central authority to issue credit accounts relating to consumer applications falling within the category. The bank selection module 806 selects a bank (in the example shown, bank 808₁ is selected) that has not previously been selected to issue a credit account for the consumer, allowing the approved bank to approve the individual account within the category and issue credit according to the preapproved terms.

A decision engine 810 is associated with each bank, and, analogously to decision engine 608 of FIG. 6, receives the application 802. The decision engine 810 determines whether the bank will issue an account to a user based on the contents of the application. As illustrated in conjunction with categorized applications, the decision engine determines whether the bank should issue a credit account to the user in accordance with the previously-bid consumer terms and incentive terms, such as would be arrived at via the bidding processes described above in FIG. 7.

A decision determination operation 812 determines whether the decision engine 810 resulted in an offer of a credit account based on the categorized application and incentive terms. If the decision engine 810 determines that a credit account is to be issued, the decision determination operation 812 causes operation to branch “yes”, resulting in issuance of a credit account 814 to the consumer, such as by issuing a credit card to the consumer. Following operation of the methods and systems 800 to issue a credit account, the newly-established credit account can be continually (or periodically) monitored and evaluated to improve credit terms for the consumer, the issuing bank, and the central authority, using methods analogous to those described above in conjunction with FIG. 4.

If the decision engine 810 determines that a credit account should not be issued, the decision determination operation 812 causes operation to branch “no” to a bank reselection operation 816. The bank reselection operation 816 determines whether another bank exists within the group of banks associated with a category which has not yet denied a credit account to the consumer based on the consumer application 802. If another bank does exist within that group, the bank reselection operation 816 assists with routing the consumer application to the remaining banks, to allow those banks an opportunity to evaluate the application 802. If no other banks exist, the application generally should be recategorized into a higher risk category, allowing that consumer to obtain a credit account, but possibly at differently-negotiated terms based on the bids received for the new category in which the application falls. Therefore, if the bank reselection operation 816 determines that banks associated with the category exist and have not rejected the application, operational flow branches “yes” to the bank selection module 806 for selection of a new credit bank 808. If the bank reselection operation 816 determines that no additional banks exist, operational flow branches “no” to return to the categorization module 804 for recategorization of the application, and reprocessing in accordance with the banks associated with the newly-selected category for the application.

Referring now to FIGS. 9-11, various bidding processes are described which can be used by the central authority or issuing bank to solicit and receive bids on consumer terms and bank incentives. One or more of the methods and systems described in these figures can be used to obtain bids from credit banks as relating to individual lines of credit, establishing customer and bank terms for programs to be offered by the central authority, or establishing customer and bank terms for various categories of received credit applications. FIGS. 9-11 illustrate various functions performed by a central authority or issuing bank, as well as functions performed by one or more credit banks. Varying the steps performed by each of these banks allows the central authority control over the redundancy of bids, ratings, and other steps used to receive bids for customer and institutional terms. By maximizing the group of bidders for both consumer terms and institutional terms, the best terms for both the customer and the central authority or issuing bank can be achieved.

The methods and systems described in these figures relate to either issuance of a new credit account in accordance with a program or category of consumers applying for credit, issuance of a new individual credit account, or an update of credit account terms as described in FIG. 4.

FIG. 9 is an exemplary embodiment of a schematic representation of methods and systems 900 for bidding on consumer terms in fluid financial markets. The consumer terms bidding can be with respect to an individual consumer, or a program offered to a variety of consumers having preset consumer terms, or a category of applications as defined by a central authority or an issuing bank. In the methods and systems 900 described in this figure, an individual application, a defined category, or a proposed program (illustrated collectively as object 902) are provided a rating by a rating module 904. The rating module 904 generates a rating based on financial criteria relating to the creditworthiness of the individual or potential individuals to be included in the program or category. The rating module 904 can generate a rating based on any of a variety of criteria, or can send financial information to an external entity for rating, such as could be accomplished via a FICO score generated by Fair Isaac Corp.

The rating generated by the rating module 904 is transmitted alongside the application or definition of the program or category to a plurality of deciding entities 906_{1-N}. The deciding entities 906_{1-N} each includes decision logic that accepts or rejects an application, category, or program, and each generate a bid 908_{1-N} relating to the received information. Each bid 906_{1-N} includes consumer terms, such as an interest rate, credit limit, and annual fee. One or more bids may be a rejection of the application based on the specific terms provided to the deciding entity, such as a low credit score, low income, or other factors.

In a possible embodiment, the deciding entities 906_{1-N} correspond to “black box” modules provided to the central authority for entry of application or applicant information and output of bid information relating to an interest rate, annual fee, and total line of credit that the bank associated with that deciding entity would be willing to extend to a consumer based on the information received. In a further possible embodiment, the deciding entities 906_{1-N} correspond to the deciding banks themselves, and applicant information is routed directly to those banks. Other embodiments are possible as well.

A bid selector module 910 selects the best bid from among the bids 908_{1-N}, and outputs selected consumer terms, which represent the best overall combination of consumer credit terms. At this point, a line of credit can be issued and updated periodically, as described above with respect to the modules 414-430 of FIG. 4.

FIG. 10 is a further exemplary embodiment of a schematic representation of methods and systems 1000 for a method of bidding on consumer terms in fluid financial markets. The methods and systems 1000 generally correspond to those described in FIG. 9; however, in place of the rating module 904 a plurality of rating modules 1004_{1-N} are used. Each of the rating modules 1004_{1-N} independently rates the application, category, or program, according to criteria specific to a deciding entity 906_{1-N}.

In certain embodiments, the rating modules 1004_{1-N} are controlled by credit banks 906 that provide independent rating criteria for their corresponding rating module 1004. In further embodiments, a central authority controls the rating modules but not the deciding entities, generating separate ratings for each deciding entity and outputting the ratings to corresponding banks. In still other embodiments, a central authority controls the rating modules 1004_{1-N} and black box deciding entities 906_{1-N}, but separate ratings are generated for deciding entities which require different types of rating inputs.

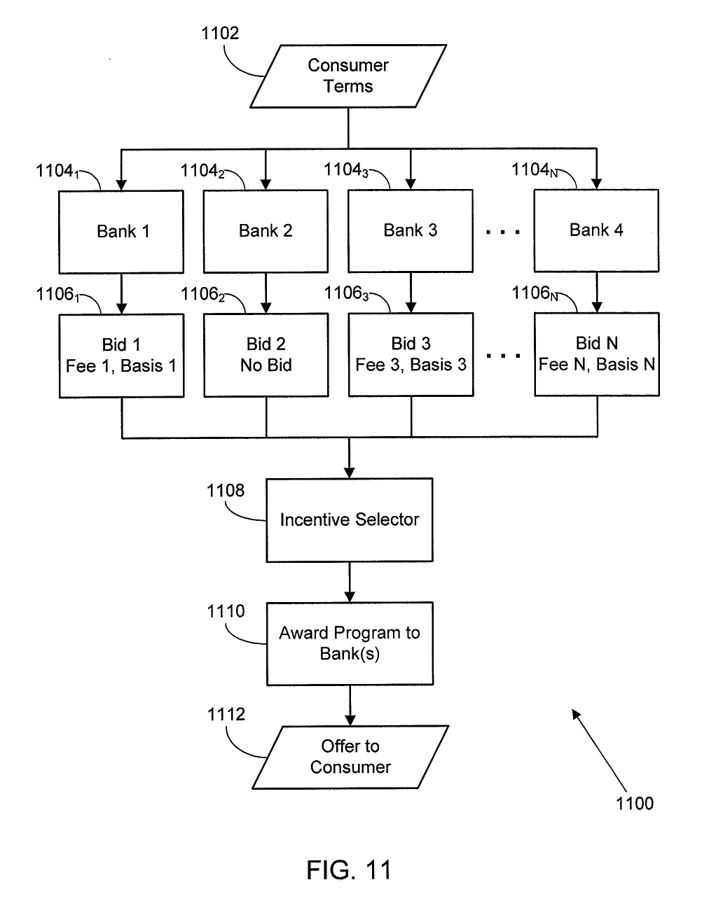

FIG. 11 is an exemplary embodiment of a schematic representation of methods and systems 1100 for bidding on incentive terms in fluid financial markets. The methods and systems 1100 generally correspond to a bidding process for incentives to be paid to a central authority to allow the banks (e.g. credit banks) to offer credit accounts to consumers applying to the central authority for credit accounts. The methods and systems 1100 receive a set of consumer terms 1102, which includes interest rates, credit limits, fees, and other information relating to consumer charges.

The consumer terms 1102 are distributed to a plurality of banks 1104_{1-N}. The banks 1104_{1-N} can correspond to the group of banks allowed to bid on customer terms via a decision entity associated with those banks, as described in FIGS. 9-10. Alternatively, the banks 1104_{1-N} can be a subset of that group of banks, or can be a different group of banks altogether.

Each of the banks 1104_{1-N} outputs a bid 1106_{1-N} on the incentives that bank would be willing to offer to the central authority or other entity (e.g. an issuing bank, as described above). The incentives, also referred to herein as bank incentives, can include basis points or a bounty to be paid in exchange for the right to offer a credit account to the consumer. Basis points, as referred to herein, correspond to a percentage of interest collected by the credit bank, while a bounty refers to a one-time fee paid for the right to provide a credit account for the consumer. The bids can include different combinations of basis points and bounties (referred to in the figures as a “fee”), or other incentives. Certain bids can be outright rejections or can correspond to a bank declining to offer an incentive to the central authority or other financial entity.

An incentive selection module 1108 collects the various bids 1106_{1-N} received from the banks 1104_{1-N} and selects the bid that includes the “best” incentives for the central authority. The best incentives selected by the incentive selection module 1108 can vary in time, and will generally correspond to the most desirable combination of basis and bounty offered to the central authority. For example, if the central authority prioritizes upfront payment, the incentive selection module 1108 can be configured to prefer (and therefore select) a bid having a higher bounty. Conversely, if the central authority prioritizes an ongoing revenue stream, the incentive selection module 1108 can be configured to prefer a bid having a higher basis.

In certain embodiments, the incentive selection module 1108 selects more than one bank from the set of banks 1104_{1-N} that offer incentives to the central authority. In such embodiments, one of the banks is selected for each individual credit account to receive the right to accounts receivable related to that account. An award module 1110 provides the benefit of accounts receivable relating to the application, program, or category to one or more credit banks. In the case of an application, the award module 1110 awards the accounts receivable to a single credit bank; however, for programs or categorized applications, one or more credit banks may be awarded a portion (e.g. a percentage) of the applications associated with the program or category.

An offer 1112 to a consumer allows the individual consumers (e.g. related to individual applications or falling within a program or category) to accept the account terms, resulting in issuance of a credit account to the consumer in accordance with the consumer terms and bank incentives. The offer 1112, when accepted, results in transmission of any bounties included in the incentive terms, and initiation of basis points payable to the central authority or issuing bank. In embodiments where a portion of the bounty is paid to a previous credit bank, that payment is made as well.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A system that provides for fluid financial markets, the system comprising:
an issuing module that issues a credit account to a consumer based on a rating and tied to a credit bank;
an update module that updates the rating over time based on financial factors related to the consumer; and
a financial module that allows the credit bank to change over time based on the rating.

2. The system of claim 1, wherein the issuing module grants to the credit bank a limited-time right to accounts receivable related to the credit account.

3. The system of claim 1, wherein the financial module allows the credit bank to change periodically.

4. The system of claim 1, wherein the financial module allows the credit bank a right of first refusal prior to changing to a second credit bank.

5. The system of claim 1, wherein the credit account is associated with a program offered by a central authority.

6. The system of claim 1, further comprising:
a categorization module that places a consumer application in a category based on the rating; and
a selection module that selects the credit bank based on the category.

7. The system of claim 1, wherein the credit bank issues the credit account to the consumer.

8. A method that provides for fluid financial markets, the method comprising:
issuing a credit account to a consumer, based on a rating assigned and associated with a first financial entity holding the account receivable;
updating the rating over time based on financial factors related to the consumer;
communicating the updated rating to a plurality of financial entities;
receiving at least one offer to hold the account receivable based on the updated rating; and
selecting the offer and associating the credit account to a new financial entity based on the offer.

9. The method of claim 8, wherein issuing a credit account to a consumer comprises granting to the credit bank a limited-time right to accounts receivable related to the credit account.

10. The method of claim 8, wherein updating the rating over time comprises periodically updating the rating.

11. The method of claim 8, further comprising allowing the first financial entity a right of first refusal prior to selecting the offer and associating the credit account to a new financial entity.

12. The method of claim 8, wherein the credit account is associated with a program offered by a central authority.

13. The method of claim 8, wherein the credit bank issues the credit account to the consumer.

14. The method of claim 8, further comprising:
placing a consumer application in a category based on the rating; and
selecting the credit bank based on the category.

15. The method of claim 8, further comprising receiving a fee from the new financial entity.

16. The method of claim 8, further comprising transferring a fee from the new financial entity to the first financial entity.

17. A method that provides for fluid financial markets, the method comprising:
soliciting bids for consumer terms relating to a credit account;
selecting a set of consumer terms from the bids;
soliciting bids for incentive terms relating to the credit account based on the set of consumer terms;
selecting a set of incentive terms relating to the credit account, the set of incentive terms relating to a credit bank; and
associating an account receivable for the credit account with the credit bank.

18. The method of claim 17, further comprising issuing a credit account to a consumer.

19. The method of claim 17, wherein the credit account corresponds to a program offered by a central authority.

20. The method of claim 17, wherein the credit account is a prospective credit account falling within a predefined category.

21. The method of claim 17, wherein updating the consumer terms and the incentive terms occurs periodically.

22. The method of claim 17, wherein the consumer terms include an interest rate and an annual fee.

23. The method of claim 17, wherein the incentive terms include at least one of a bounty or basis points.

24. The method of claim 23, further comprising paying at least a portion of the bounty to a previous credit bank.

25. The method of claim 17, further comprising updating the consumer terms and the incentive terms relating to the credit account.
